(19) United States
(12) Patent Application Publication
(10) Pub. No.: US 2025/0379012 A1
(43) Pub. Date: Dec. 11, 2025

(54) DEADMAN SWITCH SYSTEM AND METHOD FOR CONTROL OF ABRASIVE BLASTING APPARATUS

(71) Applicant: Reco Atlantic LLC, Baltimore, MD (US)

(72) Inventor: John Russell RODEN, Bel Air, MD (US)

(21) Appl. No.: 19/066,525

(22) Filed: Feb. 28, 2025

Related U.S. Application Data
(60) Provisional application No. 63/656,713, filed on Jun. 6, 2024.

(51) Int. Cl. H01H 21/22; B24C 9/00; G05G 1/04; H01H 21/04

(52) U.S. Cl. CPC H01H 21/22; B24C 9/00; G05G 1/04; H01H 21/04

(57) ABSTRACT

A deadman switch system for controlling an abrasive blasting apparatus. The deadman switch system comprises a casing, a first toggle switch mounted to the casing, a blast light including a light source provided in the casing, and a toggle lever retainer configured to be attached to an operator of the abrasive blasting apparatus via a flexible connector. The first toggle switch includes a first toggle lever having an “ON” position and a central “OFF” position. The toggle lever retainer is configured to be selectively placed between the toggle lever in the “ON” position and the casing so as to hold the first toggle lever in the “ON” position. Moreover, the blast light simultaneously turned on when the toggle lever of the first toggle switch is placed in the “ON” position.

### CROSS-REFERENCE TO RELATED APPLICATION

This application claims the benefit under 35 U.S.C. 119 (e) of U.S. Provisional Patent Application Ser. No. 63/656,713 filed Jun. 6, 2024 by Roden, J. R., which is hereby incorporated herein by reference in its entirety and to which priority is claimed.

### FIELD OF THE INVENTION

The disclosed invention relates to control systems for abrasive blasting or sandblasting systems in general. More particularly, the disclosed invention is directed to a deadman switch system for operating an abrasive blasting (or sandblasting) system by incorporating a light that targets and illuminates the blasting site in order to improve accuracy and enhance safety.

### BACKGROUND OF THE INVENTION

Deadman switches are well known and are used in a wide variety of industrial applications to operate devices and/or to prevent the operation of such devices. The Occupational Health and Safety Organization (OSHA) requires a safety system on all abrasive blasting (also known as sandblasting) equipment, as well as on other similar equipment. Abrasive blasting is a well-known technique with many applications, including cleaning metal surfaces such as boat hulls, bridges, and the like. In abrasive blasting, a flow of compressed air entrains blast media such as sand, grit or glass beads, metal balls, i.e., a mixture of pressurized air and the abrasive blasting media, and directs the mixture through a nozzle to the area requiring cleaning or blasting. The high-pressure air/media mixture is fed through a blast hose and out a blast nozzle onto the surface to be cleaned. The abrasive blasting is the operation of forcibly propelling a stream of abrasive material, such as sand, grit or glass beads, metal balls etc., under high velocity against a surface to smooth a rough surface, roughen a smooth surface, shape a surface, and/or remove surface contaminants, such as paint or rust. A pressurized fluid, typically compressed air, propels the blasting material so that it impacts the surface with sufficient force to remove the surface contaminants.

Many safety systems include what is referred to in the art as a “deadman control.” A deadman control is a device that stops the machinery when the control is released or deactivated. To enable a user to safely control an abrasive blasting apparatus, a deadman's switch is usually mounted to the blast nozzle that the nozzle operator holds to direct where the media impinges. When actuated by a user, the deadman switch causes the abrasive blasting apparatus to deliver compressed air and blast media via the nozzle. On release, the flow of both compressed air and blast media is stopped.

These controls have been implemented as mechanical, pneumatic and electric deadman controls. In general, the deadman switches require prolonged engagement or actuation by a user who, for one reason or another, may have his or her attention distracted from operation of the blasting system. Specifically, the nozzle operator is often focused on the operation of the system and takes the operability of the switch for granted. The deadman control increases the safety of the operation, by requiring that the switch be actively engaged in order for the blasting system to be “ON.”

Deadman switches are designed to function in a fail-safe mode, wherein the switch is automatically in an OFF position when certain conditions are not met. Typically, the failure to apply operating stimulus, such as grasping the switch, results in an immediate signal to a control system to shut down blasting. Such switches and controls are provided in many industrial applications, including blasting systems, power tools, industrial equipment and machinery and the like. The deadman switches are designed to prevent actuation of the control device when the nozzle operator's attention is distracted. These switches permit operation of the device only when they are engaged and otherwise prevent the transmission of electrical, pneumatic, or hydraulic power to valves and other devices required to operate the machine.

Traditional abrasive blasting systems use separate deadman switches and blast lights, each requiring individual mounting, wiring, and power sources. Consequently, conventional abrasive blasting systems require an operator to separately control the deadman switch and an external light source, leading to unnecessary complexity. Moreover, the deadman switches and blast lights typically clamp separately to a blast hose, which can result in slippage, misalignment, or rotational movement.

While used frequently, known deadman switch assemblies for abrasive blasting systems, such as deadman switch assemblies, are nevertheless susceptible to improvements that enhance their performance, applicability, cost and attractiveness. With this in mind, a need exists to develop an improved deadman switch system for an abrasive blasting system that advances the art.

### SUMMARY OF THE INVENTION

A first aspect of the invention is a deadman switch system for controlling an abrasive blasting system. The deadman switch system comprises a casing, a first toggle switch mounted to the casing, a blast light including a light source positioned in the casing, and a toggle lever retainer configured to be attached to an operator of the abrasive blasting system via a flexible connector. The first toggle switch includes a first toggle lever having an “ON” position and a central “OFF” position. A toggle lever retainer is configured to be selectively placed between the toggle lever in the “ON” position and the casing, so as to hold the first toggle lever in the “ON” position. The blast light is automatically activated the moment the deadman switch is engaged.

According to a second aspect of the invention, a method is provided for using a deadman switch system for controlling an abrasive blasting apparatus. The method comprises the steps of providing a deadman switch system according to the first aspect of the present invention, and attaching the toggle lever retainer to the operator of the abrasive blasting apparatus via the flexible connector.

Next, the first toggle lever of the first toggle switch is moved to the “ON” position to activate the abrasive blasting apparatus. Then, the toggle lever retainer is wedged between the first toggle lever in the “ON” position and the casing to hold the first toggle lever in the “ON” position. Removal of the toggle lever retainer from wedging the first toggle lever in the ON position causes the controller to immediately deactive the blasting apparatrus and cease flow of the blasting media.

Other aspects of the invention, including apparatus, systems, methods, and the like which constitute part of the invention, will become more apparent upon reading the following detailed description of the exemplary embodiments and viewing the drawings.

### BRIEF DESCRIPTION OF THE DRAWINGS

The accompanying drawings are incorporated in and constitute a part of the specification. The drawings, together with the general description given above and the detailed description of the exemplary embodiments and methods given below, serve to explain the principles of the invention. In such drawings:

FIG. 1 is a rear perspective view of a deadman switch system according to an exemplary embodiment of the present invention;

FIG. 2 is a front perspective view of the deadman switch system of FIG. 1;

FIG. 3 an exploded perspective view of the deadman switch system of FIG. 1;

FIG. 4 is a cross-sectional view of the deadman switch system; and

FIG. 5 is an electric diagram of the deadman switch of the invention; and

FIG. 6 is a side elevational view of the deadman switch system in an ON position mounted to a supply hose adjacent to a blast nozzle of an abrasive blasting apparatus.

### DETAILED DESCRIPTION OF EXEMPLARY EMBODIMENTS AND EXEMPLARY METHODS

Reference will now be made in detail to exemplary embodiments and methods of the invention as illustrated in the accompanying drawings, in which like reference characters designate like or corresponding parts throughout the drawings. It should be noted, however, that the invention in its broader aspects is not limited to the specific details, representative devices and methods, and illustrative examples shown and described in connection with the exemplary embodiments and methods.

This description of exemplary embodiments is intended to be read in connection with the accompanying drawings, which are to be considered part of the entire written description. In the description, relative terms such as “horizontal,” “vertical,” “front,” “rear,” “upper”, “lower”, “top” and “bottom”, “up” and “down”, “center”, as well as derivatives thereof (e.g., “horizontally,” “downwardly,” “upwardly,” “central”, etc.) should be construed to refer to the orientation as then described or as shown in the drawing figure under discussion and to the orientation relative to a vehicle body. These relative terms are for convenience of description and normally are not intended to require a particular orientation. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise. The term “operatively connected” is such an attachment, coupling or connection that allows the pertinent structures to operate as intended by virtue of that relationship. The term “integral” (or “unitary”) relates to a part made as a single part, or a part made of separate components fixedly (i.e., non-moveably) connected together. Additionally, the word “a” and “an” as used in the claims means “at least one” and the word “two” as used in the claims means “at least two”.

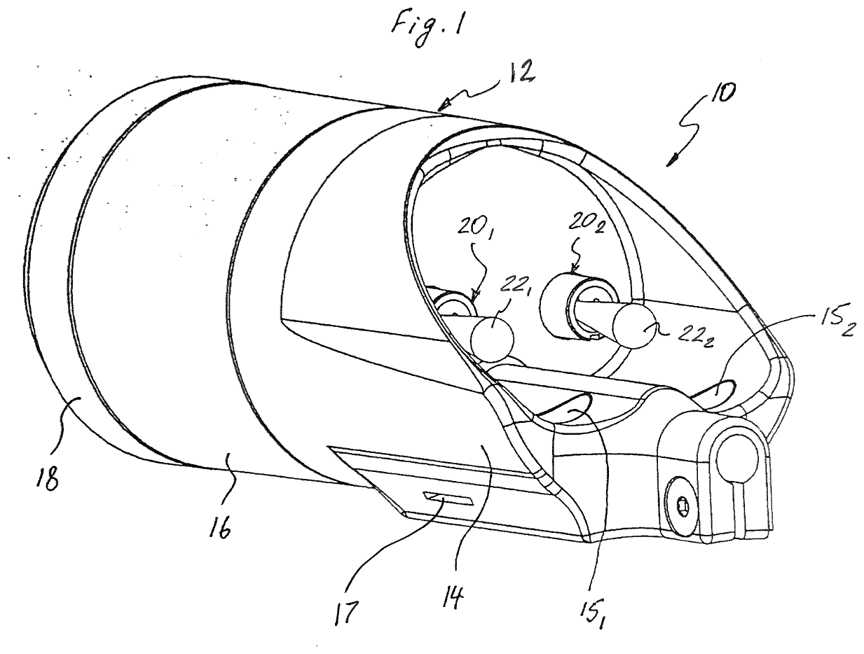

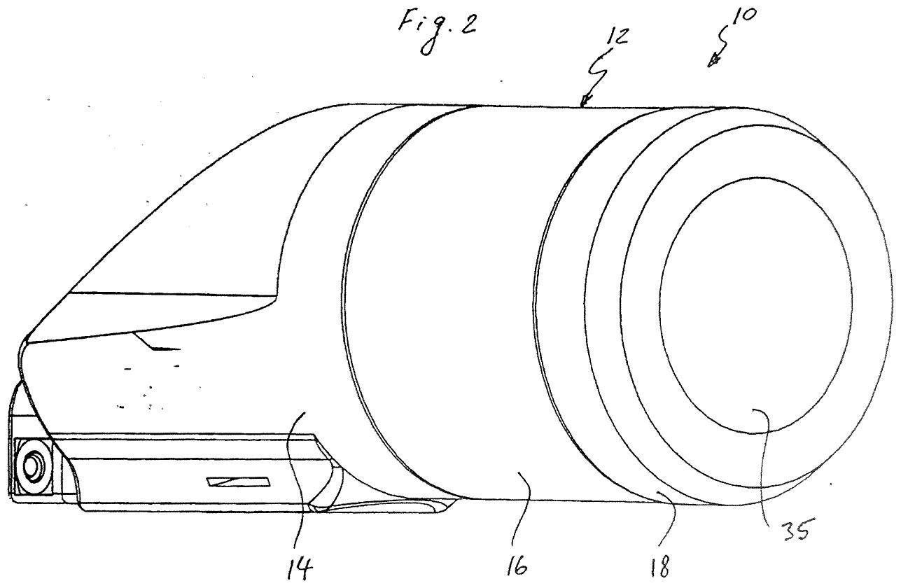

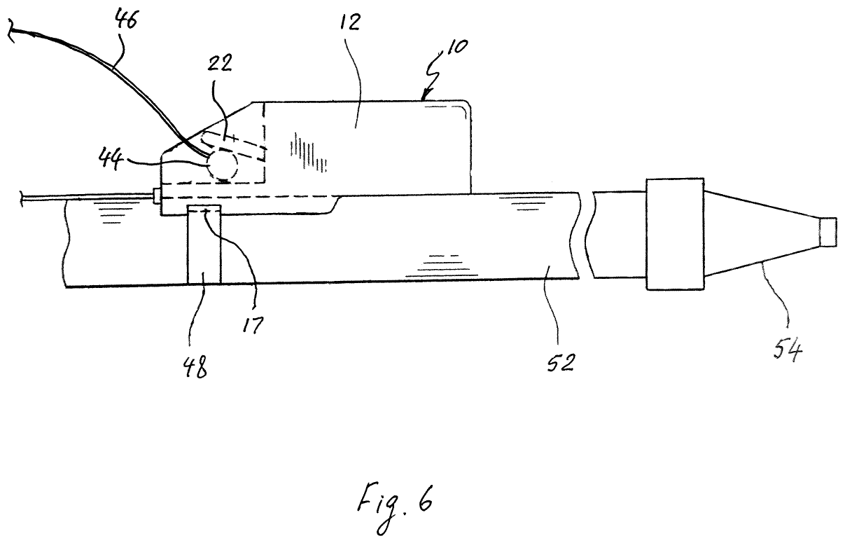

FIGS. 1-4 depict a deadman switch system 10 for an abrasive blasting or sandblasting apparatus according to the present invention. The deadman switch system 10 comprises a casing 12, including a switch housing 14, a light housing 16, and an end cap 18, as best shown in FIGS. 1-3. The switch housing 14, the light housing 16, and the end cap 18 are coaxial with each other, and removably connected, preferably threadedly attached, to each other to form the casing 12. In use, the casing 12 of the deadman switch system 10 is removably secured to a supply hose 52 attached to a blast nozzle 54 or directly to the blast nozzle 54. The deadman switch assembly 10 is removably secured to the supply hose 52 or to the blast nozzle 54 with at least one retainer, such as a hose clamp 48, as best shown in FIG. 6. Preferably casing 12 has a complementary passage 17 to receive hose clamp 48. Preferably the passage 17 is formed through the switch housing 14, as best shown in FIGS. 1, 2, 4 and 6. The casing 12 of the deadman switch system 10 is thus configured to be selectively secured to the sandblast supply hose 52 in accessible proximity to a nozzle operator when handling the blast nozzle 54 or directly to the blast nozzle 54. In the exemplary embodiment, the deadman switch system 10 is attached to the supply hose 52 with the hose clamp 48, as best shown in FIG. 6.

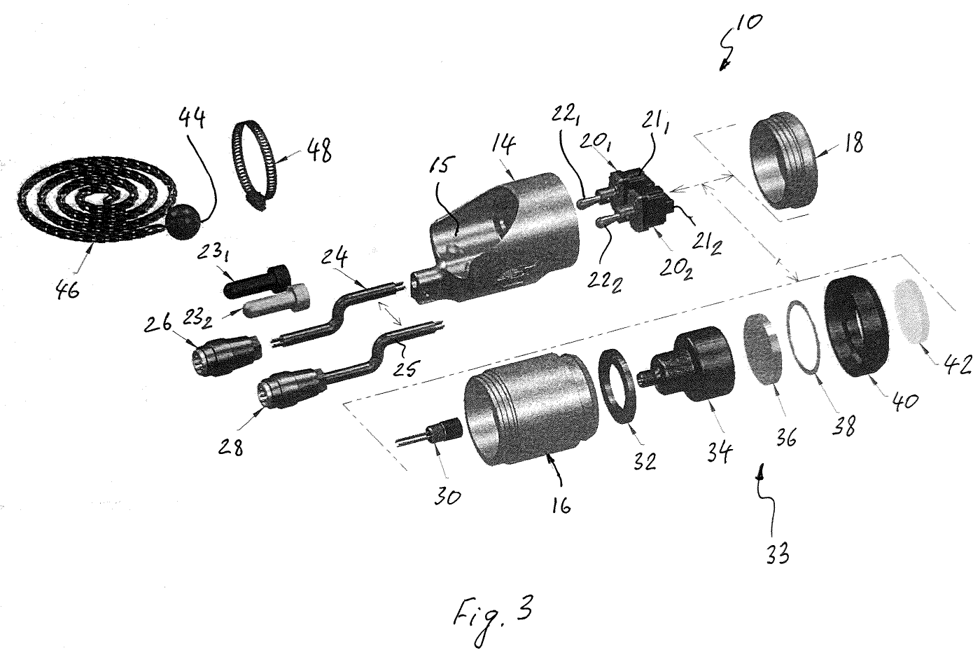

The deadman switch system 10 further comprises one or two switches, such as toggle switches, each switch mounted in the switch housing 14. According to the exemplary embodiment, the deadman switch system 10 comprises two toggle switches: a first toggle switch 20₁, and a second toggle switch 20₂. First toggle switch 20₁ actuates deadman switch system 10 and second toggle switch 20₂ turns on and off, and adjusts the pressure of the pressurized air. Further, the toggle switches 20₁ and 20₂ are disposed in a side-by-side arrangement about the casing 12 to facilitate use of both hands to control the toggle switches 20₁ and 20₂ while handling the blast nozzle 54. Alternatively, the toggle switches 20₁ and 20₂ may be staggered along the length of the supply hose 52 or the blast nozzle 54, one behind the other. The toggle switches 20₁ and 20₂ are provided for controlling a blast panel of the abrasive blasting apparatus. The toggle switches 20 send a signal to the blast panel that engage valves (auto air valve, combo valve and metering valve) attached to a blast pot, which controls the flow and pressure of compressed air and grit to the hose and blast nozzle. The first toggle or blast switch 20₁ allows or prevents the blast media to flow into the blast nozzle 54 through the supply hose 52 The second toggle or choke switch 20₂ has two functions: Choke and Blow Down (sometimes referred to as “Air”). Pressing the toggle switch 20₂ up closes the metering valve, stopping grit flow, and opens the auto-air valve, allowing compressed air to pass through, enabling the operator to “blow down” the substrate and remove debris from the blasting surface. Pressing the toggle switch 20₂ down engages the Choke function, which opens the grit valve fully to clear any obstruction and then returns it to the previously set position. Thus, the second toggle or choke switch 20₂, when activated, temporarily increases the fluid pressure urging the blast media to flow through the blast nozzle 54 Advantageously, this increased differential pressure allows the operator to clear the abrasive blasting apparatus of blast media blockages without assistance. Such blockages impede use of the blasting system and need to be cleared to allow continued operation. The choke switch 20₂ is activated by the operator to clear blockages in a safer and more effective manner-Choke is activated by pressing down on the right toggle switch 20₂. The first switch 20₁ includes a first (or blast) switch housing 21₁ and a first (or blast) toggle lever 22₁, while the second switch 20₂ includes a second (or choke) switch housing 21₂ and a second (or choke) toggle lever 22₂. Each of the toggle levers 22₁, 22₂ of each of the first and second toggle switches 20₁ and 20₂ is covered with a switch cap 23₁ or 23₂, respectively, as best shown in FIG. 3. Preferably, the first (or blast) and second (or choke) switch caps 23₁ and 23₂ are different colors in order to allow easy differentiation by the user.

Preferably the blast switch 20₁ and the choke switch 20₂ are structurally identical. In view of these similarities, and in the interest of simplicity, the following discussion will use a reference numeral without a letter to designate an entire group of identical structures. For example, the reference numeral 20 will be used when generically referring to each of blast switch 20₁ and choke switch 20₂ rather than reciting all three reference characters. Similarly, the reference numeral 21 will be used when generically referring to each of blast switch housing 21₁ of blast switch 20₁ and the choke switch housing 21₂ of the choke switch 20₂ rather than reciting all three reference characters. Also, the reference numeral 22 will be used when generically referring to each of the blast lever 22₁ and the choke lever 22₂ rather than reciting all three reference characters. Likewise, the reference numeral 23 will be used when generically referring to each of the switch caps 23₁ or 23₂.

The toggle lever 22 of each of the toggle switches 20 is movable between ON and OFF positions. Each the toggle switches 20 is preferably a 3-position toggle switch: two (up and down) ON (or activation) positions of the toggle lever 22, and the spring biased central (or neutral) OFF position in the center, i.e., between the two ON positions (i.e., a central “OFF” position). The switches 20 are preferably biased into the OFF position. In other words, each of the toggle switches 20 can be pushed both down and up and hold to function.

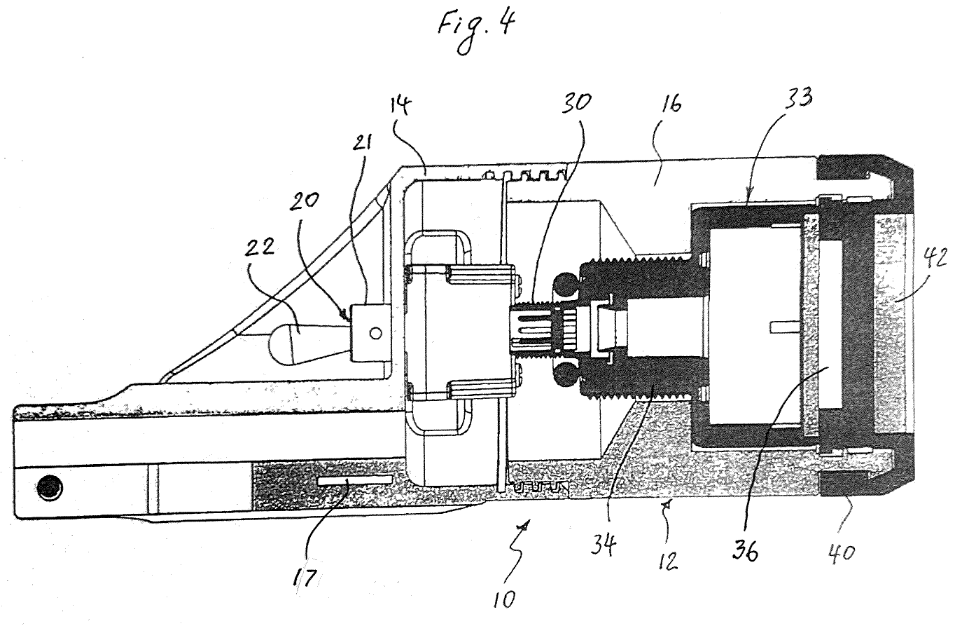

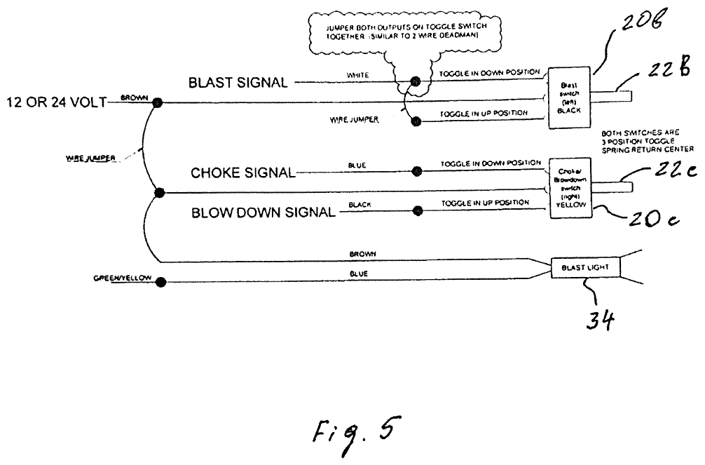

The assembled deadman switch system 10 further comprises a blast light 33, including a light source 34, such as an LED, disposed in the light housing 16, as best shown in FIGS. 3 and 4. The casing 12 further comprises a gasket seal 32 disposed between the light housing 16 and the LED 34, a primary lens 36, a snap ring 38, a front bumper 40, and an interior lens 42 disposed inside end cap 18, as best shown in FIGS. 3 and 4. The gasket seal 32 seals the primary lens 36 and all other components behind it and from the outside, and acts as a sealed barrier between the primary lens 36 and a front of the light housing 16. The front bumper 40 has an open end aligned with LED 34 and lens 42 and through which the light of the LED 34 shines. The front bumper 40 protects the front of the blast light modular housing, holds the exterior lens in place, and seals the entire blast light unit in, preventing grit, dust and debris from getting inside. The deadman switch system 10 further comprises a field wireable plug 26 electrically connected to blast switch 20₁ via a 4-wire cord 24, and an electrical connector 28 electrically connected to the choke switch 20₂ via a 4-wire cord 25, as best shown in FIG. 5. The term “field wearable” means that the wires in the deadman cord 24 are mechanically connected (bolted) to the plug 26 rather than molded (soldered) to the plug, so that operators can more easily modify the connection to attach to their existing control systems and deadman cords 24. FIG. 5 shows a 4-wire deadman switch layout with the blast light 33 using a 5-conductor wire cable. The LED 34 is activated when the system is powered and the deadman switch system 10 may be activated by the toggle lever 22 of one of the toggle switches 20 in the ON position. Similarly, when the deadman switch system 10 is deactivated, the LED 34 of the blast light 33 is simultaneously turned off. The LED 34 is preferably connected to the toggle switches 20 via an M12 electrical connector as shown in FIG. 3.

The deadman switch system 10 includes a toggle lever retainer, preferably in the form of a safety ball 44 attached to a flexible connector 46, such as a flexible cord or chain, at one (or proximal) end of the flexible connector 46, as best shown in FIG. 3. A distal end of the flexible connector 46 is attachable to the operator of the blast nozzle 54 of the abrasive blasting apparatus, such as by being secured around a wrist of the operator. Thus, the safety ball 44 is attached to the flexible connector 46 and then to the operator, for example around the wrist of the operator.

As best shown in FIGS. 1 and 3, the switch housing 14 includes first and second concave recesses 151 and 152, respectively, each configured to receive the safety ball 44 therein to position and maintain the toggle lever 22 of one of the toggle switches 20 in the ON position, and thus to operate the respective switch 20. In other words, the safety ball 44 is arranged to be selectively placed (or sandwiched, wedged, blocked) between the recess 15 in the casing 12 and the toggle lever 22 of the corresponding toggle switch 20 in the ON position, as best shown in FIG. 6 in broken lines, thus allowing the nozzle 10 of the abrasive blasting apparatus to operate. Moreover, each of the concave recesses 151 and 152 is sized and arranged to receive the safety ball 44. If the safety ball 44 is removed from its wedging position, then the switch 20 is automatically switch by the spring bias to the OFF position, and the blasting system ceases operation. The safety ball 44 may be removed should the operator drop the nozzle 54, for example. Alternatively, as noted above, the deadman switch system 10 includes one toggle switch 20, while the switch housing 14 includes one concave recess 15 configured to receive the safety ball 44.

It is to be understood that the concave recesses 151 and 152 are structurally and geometrically identical. In view of these similarities, and in the interest of simplicity, the following discussion may use a reference numeral 15 when generically referring to the concave recesses 151 and 152 rather than reciting all three reference characters.

In operation, the toggle switch 20 is lifted to the ON position and the safety ball 44 is placed into a corresponding concave recess 15 to support and maintain the toggle lever 22 of the toggle switch 20 in the ON position, as shown in FIG. 6 in broken line. Should the operator lose control of the blast nozzle 54, the safety ball 44 will disengage from the concave recess 15 and the toggle lever 22 of the toggle switch 20 automatically returns to the OFF position, as shown in FIGS. 1 and 4, and the flow of blast media is stopped. In this way, if the safety ball 44 is removed, the deadman switch system 10 turns to the OFF or neutral position. The deadman switch system 10 thus provides control of the blasting system via the toggle levers 22 of the blast and choke switches 20 when in an up position with the center position of the toggle levers 22 of the blast and choke switches 20 off.

The deadman switch system 10 positions the LED 34 and the toggle switches 20 in one system that is easily securable to a blasting nozzle 54. Because the LED 34 and the toggle switches 20 are assembled and located together, they provide an integrated system that contains both the blasting controls and the light used to illuminate the location to be blasted. The operator can see where the blast media is being targeted and maintain control over operation of the blasting system through the deadman switch system 10. In this way both the efficiency and safety of blasting are increased.

Thus, the deadman switch system 10 is an innovation in blasting controls. Typically, during abrasive blasting, operators of shot blast equipment use a light and a separate deadman switch at the end of a blast hose near a blast nozzle adapter. The light provides visibility in blast containment zones and the deadman switch gives the operator control over the pressure of propelled grit ejected from the blast nozzle. The light and the deadman switch heretofore have been separate from each other and individually powered by separate wiring connected to the blasting machine, such as two distinct wires. In the deadman switch system 10 of the present invention a single wire in a single bundle provides power to the deadman switch 20 and the blast light 34 in a single but modular casing 12. The disclosed invention provides a blast light and a 4-wire deadman switch into a single, repairable unit that increases utility by allowing the operator to locate where the blast media is being targeted while assuring control over operation of the blasting system. The present invention streamlines attachment to the blast hose, making it safer and easier for operators to see what they are blasting, control the pressure on the nozzle, and maneuver the blast hose into necessary positions while conducting surface preparation. Therefore, the deadman switch system 10 of the present invention uniquely integrates both into a single housing, streamlining installation, reducing wiring complexity, and improving ergonomics. Moreover, typical deadman switches are sealed units, meaning if one part fails, the entire unit must be replaced. The deadman switch system 10 of the present invention is designed with modular, easily replaceable and repairable components, including the blast light, the toggle switches 20, and electrical connectors, thus reducing downtime, lowering operational costs, and extending product lifespan, which are not found in conventional designs. Also, unlike conventional systems that require an operator to separately control the deadman switch and an external light source, the deadman switch system 10 of the present invention automatically activates the blast light the moment the deadman switch is engaged. This ensures immediate illumination of the work area without requiring a second action, thus significantly improving operator's visibility and safety. Furthermore, the deadman switch system 10 of the present invention features an optimized mounting system designed into its casing, ensuring a stable and ergonomic position on the supply hose, thus preventing unnecessary movement, improving operator control and usability. In use, the operator attaches the deadman switch system to the blasting nozzle or the hose leading to the nozzle with a hose clamp or like adjustable holding device. The remote end of the flexible connector 46 is secured to the operator, such as to the operator's wrist. The safety ball 44 is then positioned into one of the recesses 151, 152 and thereby forces the associated toggle switch 20₁, 20₂ into the ON position. Doing so causes the LED 34 to illuminate and the hose/nozzle to be activated. When the safety ball 44 is in the recess 151, the switch 20₁ is activated and blasting material is conveyed to the nozzle and targeted by the operator with the aid of LED 34. When the safety ball 44 is positioned in the recess 152 the switch 20₂ is activated and pressurized air alone is conveyed to the nozzle, in order to allow the nozzle to be cleared of accumulated blasting material. The operator may easily switch the system to OFF by removing the safety ball 44 from its recess, so that the switch 20 is automatically shifted to the OFF position via its spring bias, which stops the flow of pressurized material to the nozzle. Should the operator become distracted or drop the nozzle, doing so will cause the safety ball 44 to be removed from the recess 15 because the other end of the flexible connector 46 is secured to the operator.

The foregoing description of the exemplary embodiment of the present invention has been presented for the purpose of illustration in accordance with the provisions of the Patent Statutes. It is not intended to be exhaustive or to limit the invention to the precise forms disclosed. Obvious modifications or variations are possible in light of the above teachings. The embodiments disclosed hereinabove were chosen in order to best illustrate the principles of the present invention and its practical application to thereby enable those of ordinary skill in the art to best utilize the invention in various embodiments and with various modifications as suited to the particular use contemplated, as long as the principles described herein are followed. This application is therefore intended to cover any variations, uses, or adaptations of the invention using its general principles. Further, this application is intended to cover such departures from the present disclosure as come within known or customary practice in the art to which this invention pertains. Thus, changes can be made in the above-described invention without departing from the intent and scope thereof. It is also intended that the scope of the present invention be defined by the claims appended thereto.

What is claimed is:

1. A deadman switch system for controlling an abrasive blasting apparatus, the deadman switch system comprising:
a casing;
a first toggle switch mounted to the casing, the first toggle switch including a first toggle lever having an “ON” position and an “OFF” position;
a blast light including a light source provided in the casing in axial alignment with the casing; and
a toggle lever retainer configured to be attached to an operator of the abrasive blasting apparatus via a flexible connector;
the toggle lever retainer configured to be selectively placed between the toggle lever in the “ON” position and the casing to hold the first toggle lever in the “ON” position;
the blast light automatically actuated when deadman switch is powered on.

2. The deadman switch system as defined in claim 1, wherein the casing includes a switch housing and a light housing coaxial with the switch housing, the first toggle switch is mounted to the switch housing, the light source is mounted in the light housing, and the switch housing and the light housing are removably attached to one another.

3. The deadman switch system as defined in claim 2, wherein the switch housing includes a first concave recess configured to receive the toggle lever retainer therein to position the first toggle lever of the first toggle switch in the ON position.

4. The deadman switch system as defined in claim 3, wherein the first concave recess is complementary to the toggle lever retainer.

5. The deadman switch system as defined in claim 1, wherein the first toggle switch is a blast switch controlling blast media flow into a blast nozzle.

6. The deadman switch system as defined in claim 1, wherein the casing is secured to a supply hose adjacent to a blast nozzle or to the blast nozzle with at least one retainer strap.

7. The deadman switch system as defined in claim 1, wherein the flexible connector is at least one of a flexible cord and a chain.

8. The deadman switch system as defined in claim 1, wherein the light source is a LED.

9. The deadman switch system as defined in claim 1, further comprising a field wireable plug electrically connected to the first toggle switch via a 4-wire cord.

10. The deadman switch system as defined in claim 1, further comprising a first switch cap covering the first toggle lever.

11. The deadman switch system as defined in claim 1, further comprising a second toggle switch mounted to the casing, the second toggle switch including a second toggle lever having an “ON” position and a “OFF” position, the blast light is simultaneously turned on when the second toggle lever of the second toggle switch is in the “ON” position, and the toggle lever retainer is configured to be selectively placed between the second toggle lever in the “ON” position and the casing to hold the second toggle lever in the “ON” position.

12. The deadman switch system as defined in claim 11, wherein the casing includes a switch housing and a light housing coaxial with the switch housing, and both the first and second toggle switches are mounted to the switch housing, and the light source is mounted in the light housing.

13. The deadman switch system as defined in claim 11, wherein the first toggle switch is a blast switch controlling blast media flow into a blast nozzles, and the second toggle switch is a choke switch temporarily increasing pressure of blast media flowing through the blast nozzle.

14. The deadman switch system as defined in claim 12, wherein the switch housing includes first and second concave recesses, respectively, configured to receive the toggle lever retainer therein to position the toggle lever of one of the toggle switches in the ON position.

15. The deadman switch system as defined in claim 14, wherein each of the concave recesses is complementary to the toggle lever retainer.

16. The deadman switch system as defined in claim 11, wherein the toggle switches are disposed in a side-by-side arrangement relative to a length of the casing of the deadman switch system.

17. The deadman switch system as defined in claim 11, wherein the casing is secured to a supply hose adjacent to a blast nozzle or to the blast nozzle of the abrasive blasting apparatus with at least one retainer strap.

18. The deadman switch system as defined in claim 11, further comprising a field wireable plug electrically connected to the first toggle switch via a 4-wire cord and an electrical connector electrically connected to the second toggle switch via a 4-wire cord.

19. The deadman switch system as defined in claim 11, further comprising first and second switch caps each covering one of the first and second toggle levers, respectively, wherein the first and second switch caps are different colors to allow differentiation by the operator.

20. A method of using a deadman switch system for controlling an abrasive blasting apparatus, comprising the steps of:
providing the deadman switch system as defined in claim 1;
attaching the toggle lever retainer to the operator of the abrasive blasting apparatus via the flexible connector;
moving the first toggle lever of the first toggle switch to “ON” position to activate the abrasive blasting apparatus; and
wedging the toggle lever retainer between the first toggle lever in the “ON” position and the casing so as to hold the first toggle lever in the “ON” position.
